(19) United States
(12) Patent Application Publication
(10) Pub. No.: US 2012/0200756 A1
(43) Pub. Date: Aug. 9, 2012

(54) FLAT SCREEN WINDOW AND MULTI-FUNCTION DISPLAY

(75) Inventor: Kenneth H. Church, Orlando, FL (US)

(73) Assignee: SCIPERIO, INC., Orlando, FL (US)

(21) Appl. No.: 13/361,458

(22) Filed: Jan. 30, 2012

Related U.S. Application Data
(60) Provisional application No. 61/439,434, filed on Feb. 4, 2011.

(51) Int. Cl. H04N 5/655; H04N 5/225

(52) U.S. Cl. 348/333.01; 348/836; 348/E05.132; 348/E05.025

(57) ABSTRACT

A flat screen display (FSD) window system includes a flat screen display, a window frame operatively connected to the flat screen display, the window frame and flat screen display configured to simulate an appearance of a window. The flat screen display window system further includes a video source operatively connected to the flat screen display to provide a video signal to the flat screen display. Methods are provided for making a window in an interior wall or a basement using FSD technology. The FSD Window System can be multi purpose to include a window, a picture, a monitor or a television.

### CROSS-REFERENCE TO RELATED APPLICATIONS

This application is a non-provisional application of U.S. Provisional Application No. 61/439,434, filed Feb. 4, 2011, which is herein incorporated by reference in its entirety.

### FIELD OF THE INVENTION

The invention relates to the field of flat screen displays, and more particularly, to methods and techniques of utilizing flat screen displays to emulate a window.

### BACKGROUND OF THE TECHNOLOGY

Flat Screen Displays (FSD) are also known as Flat Screen Televisions and are manufactured in a wide variety of sizes and including large sizes. The intended use for FSD's are for computer displays, television and presentation displays. Next generation FSD are thin and light weight. This has opened up opportunities to mount flat screens and televisions on walls. Some have used this as a source for movies or to share pictures from a computer and some have utilized such to display a picture or even a fire place. In addition to this FSD's are used as monitors for security or surveillance. A camera is set outside and a signal is transmitted back to the FSD showing a view of the grounds being surveyed.

The prized office in a building has windows. Window offices can enhance the work environment. Windows however are restricted to outside walls. Some buildings will use a skylight in interior areas to bring in sunlight as an attempt to promote an enhanced work environment. In many homes there are basements which cannot have windows and many times a window may be desired that a builder did not put in and it is many times cost prohibitive to add windows.

The concept of utilizing a television or a monitor as a window has not been conducive given the nature of the physical size and awkward shape of the monitor or television. The newer and more advanced displays have a flat front glass piece which has a similar look as a window. This still appears to look like a display and it is still not a window. A need exists to convert flat screen technology providing the same appearance and function of a window. In addition to these flat displays, next generation displays will be large and flexible and will be much larger, thus allowing oversized windows or even full wall sized windows to be mimicked.

### SUMMARY OF THE INVENTION

Therefore it is a primary object, feature, or advantage of the present invention to improve over the state of the art.

It is a further object, feature, or advantage of the present invention to provide methods and processes for utilizing displays such as FSDs and proper window sill designs to give the appearance of a window.

It is a still further object, feature, or advantage of the present invention to provide one or more cameras that may face any direction on the outside of the building and use video from the one or more cameras to effectively add windows to interior walls.

It is another object, feature, or advantage of the present invention to provide a modified system to include a FSD, supporting aesthetic window borders and a camera will be integrated for a window quality experience.

According to another aspect of the present invention, a flat screen display window system includes a flat screen display, a window frame operatively connected to the flat screen display, the window frame and flat screen display configured to simulate an appearance of a window, and a video source operatively connected to the flat screen display to provide a video signal to the flat screen display.

According to another aspect of the present invention, a method for enhancing appearance of a room is provided. The method includes providing a flat screen display window system comprising a flat screen display and a frame operatively connected to the flat screen display, the frame configured to simulate an appearance of a window and mounting the flat screen display window system at a position within the room so as to simulate the appearance of the window.

According to another aspect of the present invention, a flat screen display window system is provided. The system includes a flat screen display, a window frame operatively connected to the flat screen display, the window frame and flat screen display configured to simulate an appearance of a window, and a camera operatively connected to the flat screen display, the camera configured to acquire video imagery for display on the flat screen display.

### BRIEF DESCRIPTION OF THE FIGURES

FIG. 1 is a block diagram of the FSD Window System

FIG. 2 illustrates one embodiment of the FSD Window System.

FIG. 3 illustrates a profile of one embodiment of the FSD Window System installed on a wall.

FIG. 4 is another block diagram of the FSD Window System where multiple cameras are used.

FIG. 5 illustrates the FSD Window System where a window sill is used.

### DETAILED DESCRIPTION OF THE INVENTION

Utilizing a FSD and a designed boarder with window sills, a method to assemble this that allows for a tight against the wall system is developed. A boarder may tightly couple to the monitor to give it the appearance of an embedded piece of glass within the frame. The window sill below may be tightly coupled to the glass on the display giving the appearance of a solid piece. The sill and borders will be designed in such a manner as to allow a tightly coupled connection with the display glass, but also allow for tight contact with the wall it is to be mounted on. All wires may be placed behind the wall, hidden for effect. If the FSD needs to have air flow, the window frame may be specially designed to ensure air flow without compromising the tight fit or look.

Once mounted on the wall, the FSD Window System may appear to look like a dark window. The FSD typically has a receiver and can handle video and including live video. A camera strategically set outside can be transmitted back to the FSD Window System thus displaying in real time and brilliant, life like colors from the out doors. The solid wall may look exactly like an exterior wall with a window.

The FSD Window System placed in an inner office building can also serve multi purpose, 1) as a window to the outside, 2) as a picture or painting, 3) as a monitor to display what is on a computer or 4) a television. A switch may be set up to allow the FSD Window system to switch to any mode. Where the FSD Window System serves as window to the outside, the FSD Window System may provide a view similar to what one would expect to see from a window of the office building, or may provide a view similar to what one would expect to see from a window looking out to a different location which may be geographically remote from the inner office building.

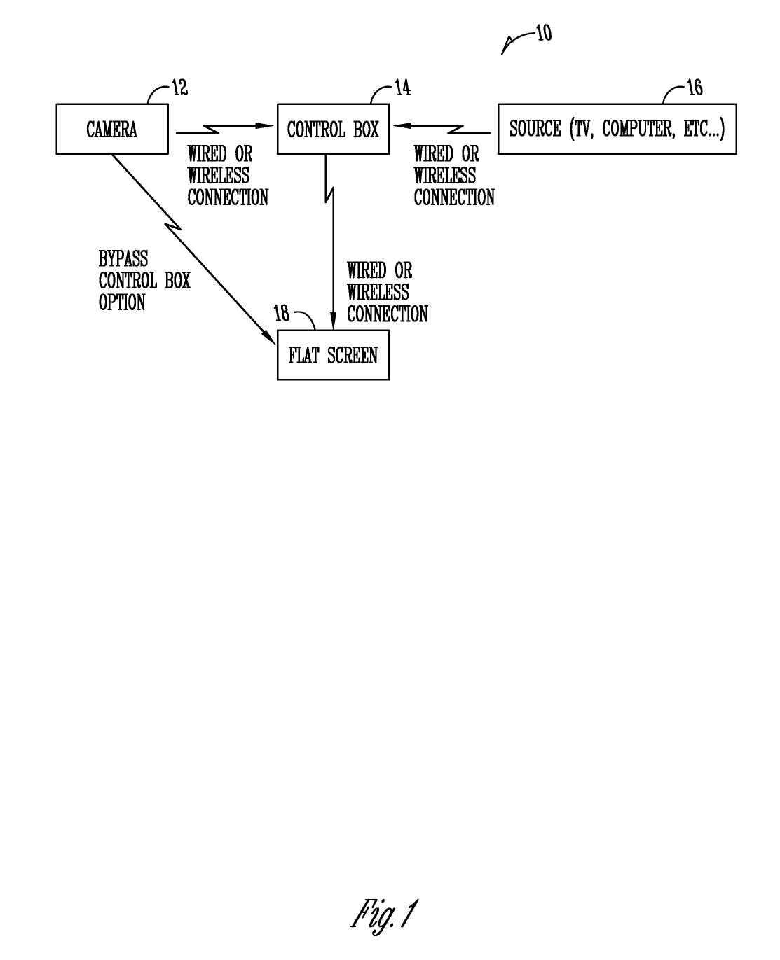

FIG. 1 illustrates a block diagram of one embodiment of the FSD Window System. As shown in FIG. 1 the FSD Window system 10 includes a camera 12 operatively connected to a control box 14. The camera 12 may be operatively connected to the control box 14 wirelessly or through a wired connection. A source 16 may also be operatively connected to the control box 14. The source 16 may be operatively connected to the control box 14 wirelessly or through a wired connection. The control box 14 may be operatively connected to a flat screen display 18. It is to be understood that the flat screen display may be of any number of types utilizing any number of different technologies such as are known or may become known in the art. The control box 14 may be operatively connected to the flat screen display 18 either wirelessly or through a wired connection.

As shown in FIG. 1, the camera 12 may be operatively connected to the flat screen display 18 directly in a manner that bypasses the control box 14. The camera 12 may be directly connected to the control box 14 wirelessly or through a wired connection.

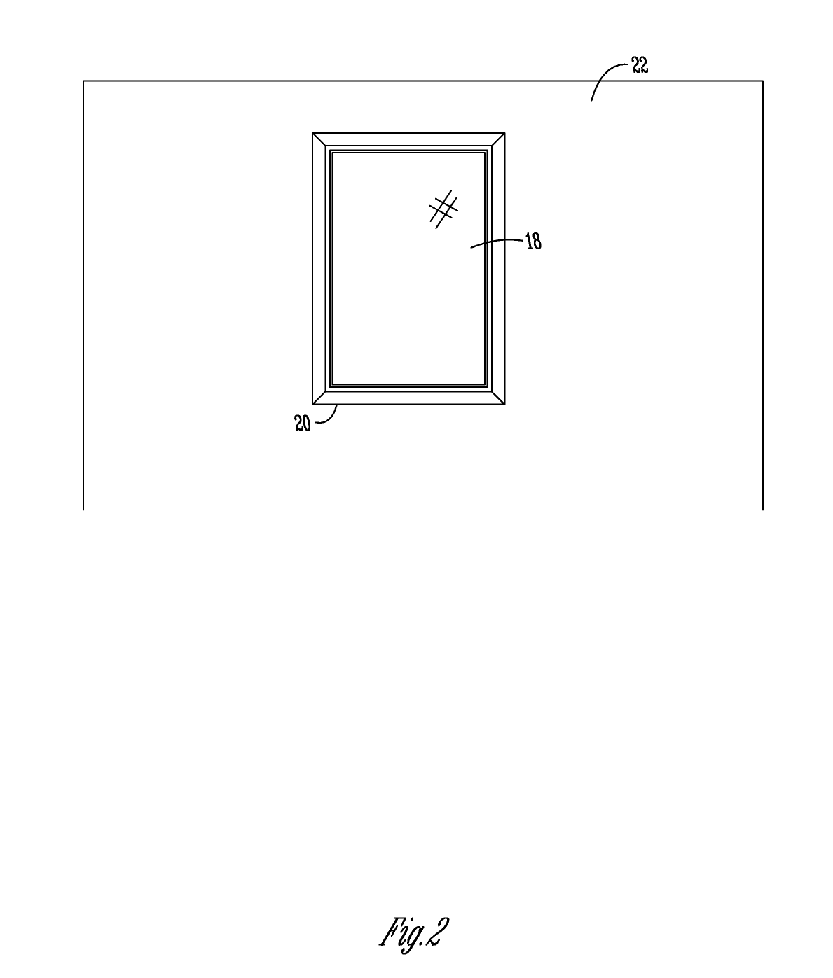

FIG. 2 illustrates the FSD Window system in an operative or installed position such as when mounted to a wall. As shown in FIG. 2, a window frame 20 is mounted to a wall 22. A flat screen display 18 is mounted within the window frame 20 and/or to the wall 22. Thus, the appearance of a window may be given. The appearance of window may be further embellished such as through the addition of shades, valances, curtains, drapes, blinds, or other types of window treatments or window dressing.

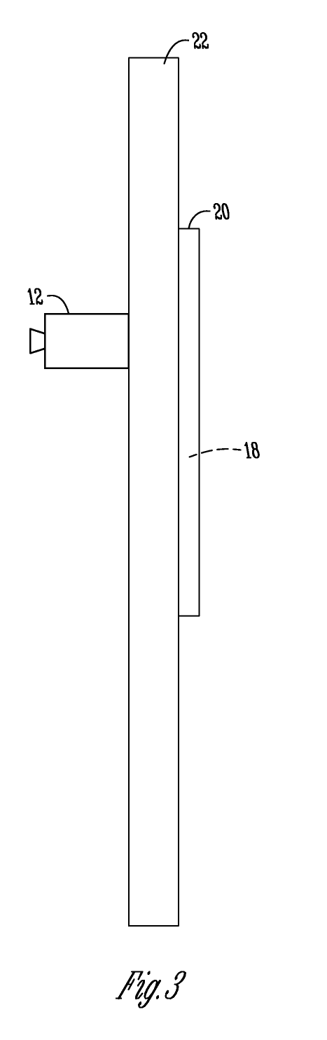

As previously explained, various video sources may be used to provide video to the flat screen display 18 which may correspond with what one looking through an actual window would expect to see. The video can come from any number of sources including from a camera providing a view generally corresponding to a view if there was an actual window present. FIG. 3 illustrates an outer wall 22 of a building. A flat screen display 18 is mounted in a window frame 20 on an interior side of the wall 22 of the building. A camera 12 is mounted on the exterior side of the wall 22 of the building. The camera 12 may be used to acquire video imagery from the outside for display on the flat screen display 18.

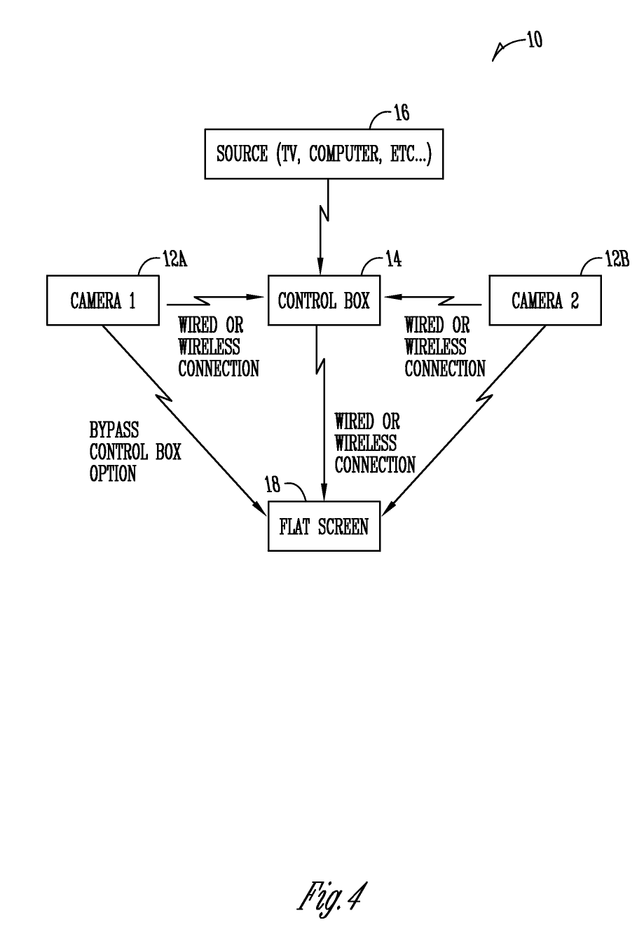

As illustrated in FIG. 4, in addition to contemplating that any type of source 16 may be used for the video, the present invention contemplates that more than one camera 12A, 12B may be used to acquire imagery. In addition, the present invention contemplates that where the flat screen display 18 uses 3D technology that more than one camera may be used to acquire video imagery and the imagery may be combined to produce 3D video.

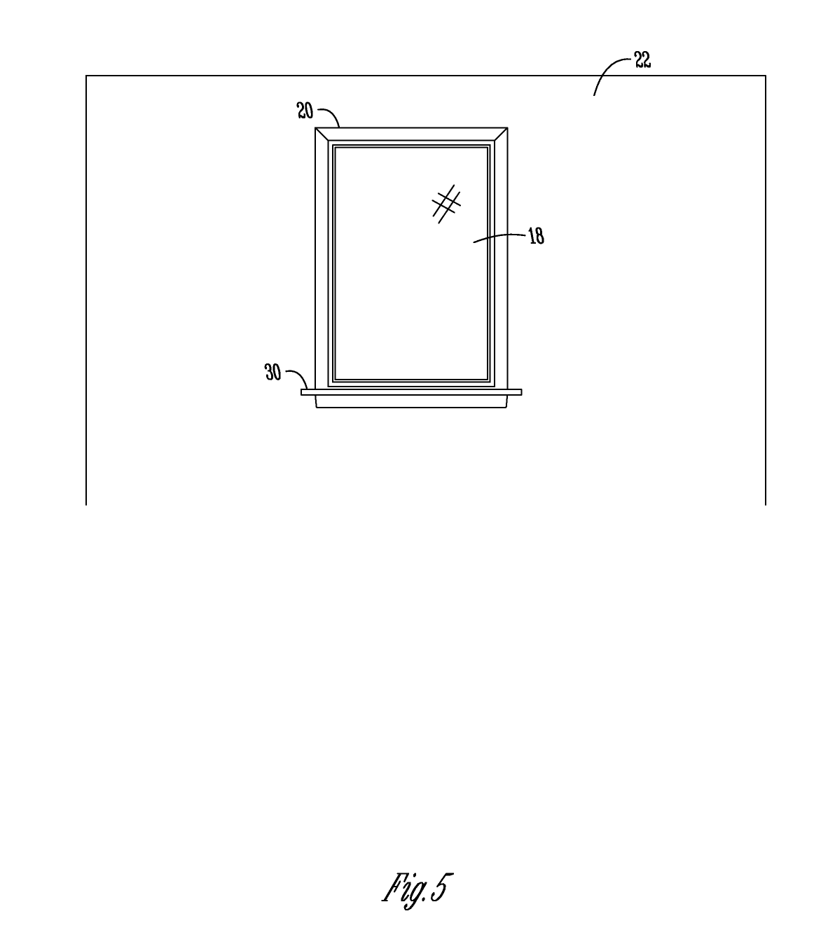

FIG. 5 illustrates another embodiment of the present invention. As shown in FIG. 5, a window sill 30 is present at the bottom of the window frame 20. The presence of the window sill 30 further assists in simulating the appearance of an actual window.

Although various embodiments are shown or discussed herein, it is to be understood that the present invention is not limited to the specific disclosure as the present invention contemplates various and numerous variations, options, and alternatives.

What is claimed is:

1. A flat screen display window system, comprising:
a flat screen display;
a window frame operatively connected to the flat screen display, the window frame and flat screen display configured to simulate an appearance of a window;
a video source operatively connected to the flat screen display to provide a video signal to the flat screen display.

2. The flat screen display window system of claim 1 further comprising a control box operatively connected to the flat screen display and the video source.

3. The flat screen display window system of claim 2 further comprising a camera operatively connected to the control box.

4. The flat screen display window system of claim 1 further comprising a window sill operatively connected to the window frame.

5. A method for enhancing appearance of a room, the method comprising:
providing a flat screen display window system comprising a flat screen display and a frame operatively connected to the flat screen display, the frame configured to simulate an appearance of a window;
mounting the flat screen display window system at a position within the room so as to simulate the appearance of the window.

6. The method of claim 6 further comprising connecting a camera to the flat screen display.

7. The method of claim 6 wherein the camera is mounted at a position outside of the room to provide video simulating a view from a window.

8. The method of claim 5 further comprising connecting the flat screen display to a control box.

9. The method of claim 8 further comprising connecting a video source to the control box.

10. The method of claim 9 further comprising sending a video signal from the video source to the control box and further sending the video signal from the control box to the flat screen display.

11. A flat screen display window system, comprising:
a flat screen display;
a window frame, the flat screen display mounted within the window frame, the window frame and flat screen display configured to simulate an appearance of a window;
a camera operatively connected to the flat screen display, the camera configured to acquire video imagery for display on the flat screen display.

12. The flat screen display window system of claim 11 wherein the window frame is mounted on an interior side of an outside wall of a building and the camera is mounted on an exterior side of the outside wall of the building.

13. The flat screen display window system of claim 11 further comprising a window sill operatively connected to the window frame.
